(19) United States
(12) Patent Application Publication
(10) Pub. No.: US 2015/0127794 A1
(43) Pub. Date: May 7, 2015

(54) Content And Device Naming Scheme

(71) Applicant: Comcast Cable Communications, LLC, Philadelphia, PA (US)

(72) Inventors: Dana Kring, Strasburg, CO (US); Robert M Steinberg, Horsham, PA (US); Chris Bygrave, Edgewater Park, NJ (US)

(73) Assignee: Comcast Cable Communications, LLC, Philadelphia, PA (US)

(21) Appl. No.: 14/069,874

(22) Filed: Nov. 1, 2013

(51) Int. Cl. H04L 12/24

(52) U.S. Cl. CPC H04L 41/00
USPC 709/223

(57) ABSTRACT

Methods and systems for managing content are disclosed. An example method can comprise receiving content at a first device. The first device can be associated with a first identifier. The method can comprise inserting the first identifier into the content. The method can also comprise providing the content comprising the first identifier to a second device associated with a second identifier. The second identifier can comprise the first identifier.

### BACKGROUND

Content services, such as content delivery, electronic program guides, customized advertising, and the like, are provided by various parties having different objectives and constraints that lead to different approaches for managing content. The differences in these approaches can create inconsistencies and technical problems when the various parties, collectively or individually, provide content and content information to consumers. Accordingly, there is a need for more sophisticated methods and systems for managing content.

### SUMMARY

It is to be understood that both the following general description and the following detailed description are exemplary and explanatory only and are not restrictive, as claimed. Provided are methods and systems for managing content. In one aspect, an example method can comprise receiving content at a first device. The first device can be associated with a first identifier. The first identifier can be inserted into the content. The content comprising the first identifier can be provided to a second device associated with a second identifier. In one aspect, the second identifier can comprise the first identifier.

In another aspect, an example method can comprise receiving content. An identifier contained within the content can be determined. A network path can be identified based on the identifier, and a device in the network path can be identified based on the identifier.

In yet another aspect, an example method can comprise providing a first identifier for a first device in a network and providing a second identifier for a second device in the network. In one aspect, the second identifier can comprise the first identifier. A network path for content comprising the first identifier can be identified.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a block diagram illustrating various aspects of an exemplary system in which the present methods and systems can operate;

FIG. 2 is a block diagram illustrating an example computing system in which the present methods and systems can operate;

FIG. 3 is a block diagram illustrating an example system for content management;

FIG. 4 is a flowchart illustrating an example method for content management;

FIG. 5 is a flowchart illustrating another example method for content management;

FIG. 6 is a flowchart illustrating yet another example method for content management;

FIG. 7 is a diagram illustrating an example network element.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The present disclosure relates to methods and systems for managing content. Specifically, a network of devices can be provided for delivering content and/or other purposes. The devices can be associated with identifiers. As content is received by a device, the device can insert an identifier associated with the device in the content. Accordingly, the identifiers from each device can be identified (e.g., determined) in the content. The identifiers can be inserted into the content such that the network topology of the devices can be determined. In one aspect, the identifiers of the devices can comprise characters that indicate devices in the network in between the device and a content source (e.g., upstream in the network from the device).

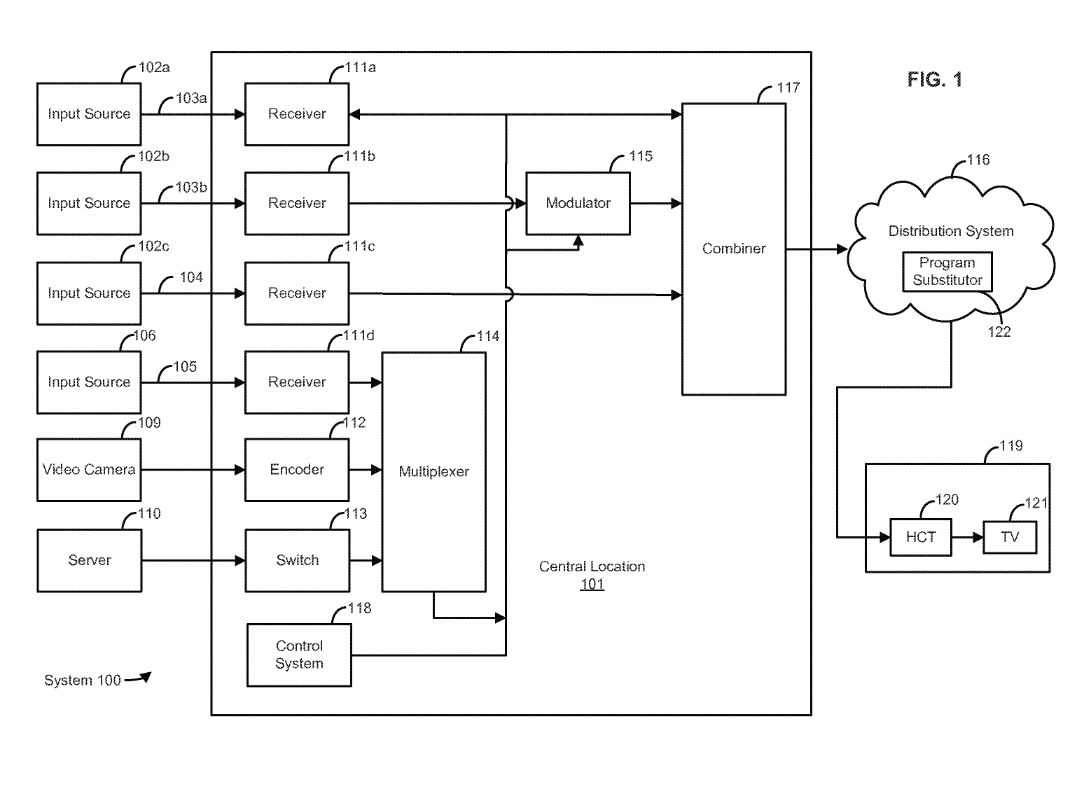

FIG. 1 is a block diagram illustrating various aspects of an exemplary system in which the present methods and systems can operate. Those skilled in the art will appreciate that present methods may be used in systems that employ both digital and analog equipment. One skilled in the art will appreciate that provided herein is a functional description and that the respective functions can be performed by software, hardware, or a combination of software and hardware.

The system 100 can comprise a central location 101 (e.g., a headend), which can receive content (e.g., data, input programming, and the like) from multiple sources. The central location 101 can combine the content from the various sources and can distribute the content to user (e.g., subscriber) locations (e.g., location 119) via distribution system 116.

In an aspect, the central location 101 can receive content from a variety of sources 102a, 102b, 102c. The content can be transmitted from the source to the central location 101 via a variety of transmission paths, including wireless (e.g. satellite paths 103a, 103b) and terrestrial path 104. The central location 101 can also receive content from a direct feed source 106 via a direct line 105. Other input sources can comprise capture devices such as a video camera 109 or a server 110. The signals provided by the content sources can include a single content item or a multiplex that includes several content items.

The central location 101 can comprise one or a plurality of receivers 111a, 111b, 111c, 111d that are each associated with an input source. For example, MPEG encoders, such as encoder 112, are included for encoding local content or a video camera 109 feed. A switch 113 can provide access to server 110, which can be a Pay-Per-View server, a data server, an internet router, a network system, a phone system, and the like. Some signals may require additional processing, such as signal multiplexing, prior to being modulated. Such multiplexing can be performed by multiplexer (mux) 114.

The central location 101 can comprise one or a plurality of modulators 115 for interfacing to the distribution system 116. The modulators can convert the received content into a modulated output signal suitable for transmission over the distribution system 116. The output signals from the modulators can be combined, using equipment such as a combiner 117, for input into the distribution system 116.

A control system 118 can permit a system operator to control and monitor the functions and performance of system 100. The control system 118 can interface, monitor, and/or control a variety of functions, including, but not limited to, the channel lineup for the television system, billing for each user, conditional access for content distributed to users, and the like. Control system 118 can provide input to the modulators for setting operating parameters, such as system specific MPEG table packet organization or conditional access information. The control system 118 can be located at central location 101 or at a remote location.

The distribution system 116 can distribute signals from the central location 101 to user locations, such as user location 119. The distribution system 116 can be an optical fiber network, a coaxial cable network, a hybrid fiber-coaxial network, a wireless network, a satellite system, a direct broadcast system, or any combination thereof. There can be a multitude of user locations connected to distribution system 116. In one aspect, the distribution system 116 can comprise one or more program substitutors 122 configured to insert and/or replace content before the content is distributed at user location 119. At user location 119, a decoder 120, such as a gateway or home communications terminal (HCT) can decode, if needed, the signals for display on a display device, such as on a television set (TV) 121 or a computer monitor. Those skilled in the art will appreciate that the signal can be decoded in a variety of equipment, including an HCT, a computer, a TV, a monitor, or satellite dish. In an exemplary aspect, the methods and systems disclosed can be located within, or performed on, one or more HCTs 120, TVs 121, central locations 101, DVRs, home theater PCs, and the like.

In an aspect, user location 119 is not fixed. By way of example, a user can receive content from the distribution system 116 on a mobile device, such as a laptop computer, PDA, smartphone, GPS, vehicle entertainment system, portable media player, and the like.

In an exemplary embodiment, the methods and systems disclosed can be located within one or more elements (e.g., devices, hardware and/or software modules) of the system 100, such as the receiver 111, encoder 112, multiplexer 114, combiner 117, modulator 115, switch 113, server 110, program substitutor 122, or other element of the system 100. For example, these elements can be configured to insert identifiers in content received by the element. One or more of the elements can be associated with a unique identifier. Several identifiers can be inserted into the same content as the content passes through each of the elements on the network. The elements can also identify the identifiers in the content. The identifiers can indicate at least a part of the topology of a network and a network path of the content.

In an aspect, the methods and systems can utilize digital audio/video compression, such as MPEG or any other type of compression. The Moving Pictures Experts Group (MPEG) was established by the International Standards Organization (ISO) for the purpose of creating standards for digital audio/video compression. The MPEG experts created the MPEG-1 and MPEG-2 standards, with the MPEG-1 standard being a subset of the MPEG-2 standard. The combined MPEG-1, MPEG-2, and MPEG-4 standards are hereinafter referred to as MPEG. In an MPEG encoded transmission, content and other data are transmitted in packets, which collectively make up a transport stream. In an exemplary embodiment, the present methods and systems can employ transmission of MPEG packets. However, the present methods and systems are not so limited and can be implemented using other types of transmission and data.

The output of a single MPEG audio and/or video coder is called a transport stream comprised of one or more elementary streams. An elementary stream is an endless near real-time signal. For convenience, the elementary stream may be broken into data blocks of manageable size, forming a packetized elementary stream (PES). These data blocks need header information to identify the start of the packets and must include time stamps because packetizing disrupts the time axis. For transmission and digital broadcasting, for example, several programs and their associated PESs can be multiplexed into a multi program transport stream.

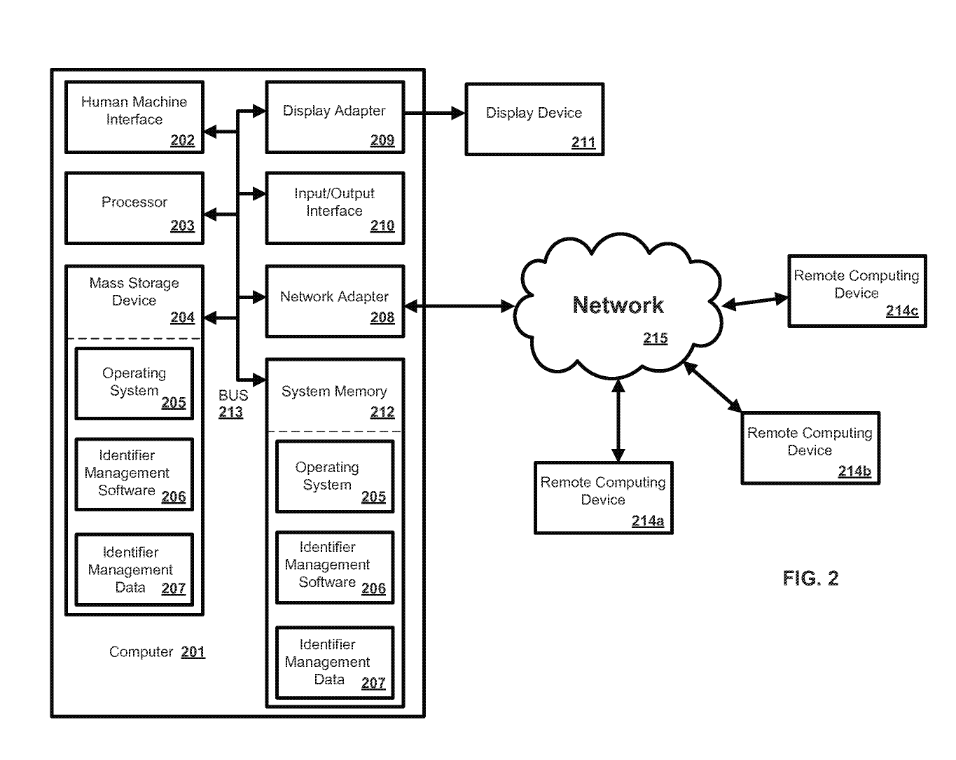

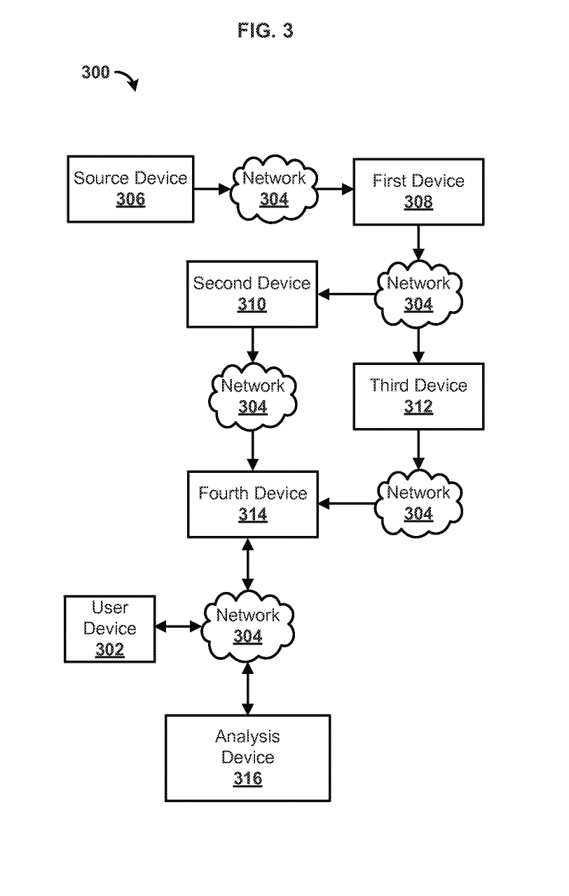

In an exemplary aspect, the methods and systems can be implemented on a computer 201 as illustrated in FIG. 2 and described below. By way of example, server 110 of FIG. 1, the source device 306, first device 308, second device 310, third device 312, fourth device 314, and/or the analysis device 316 of FIG. 3 can be a computer as illustrated in FIG. 2. Similarly, the methods and systems disclosed can utilize one or more computers to perform one or more functions in one or more locations. FIG. 2 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 201. The components of the computer 201 can comprise, but are not limited to, one or more processors or processing units 203, a system memory 212, and a system bus 213 that couples various system components including the processor 203 to the system memory 212. In the case of multiple processing units 203, the system can utilize parallel computing.

The system bus 213 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 213, and all buses specified in this description can also be implemented over a wired or wireless network connection and each of the subsystems, including the processor 203, a mass storage device 204, an operating system 205, identifier management software 206, identifier management data 207, a network adapter 208, system memory 212, an Input/Output Interface 210, a display adapter 209, a display device 211, and a human machine interface 202, can be contained within one or more remote computing devices 214a,b,c at physically separate locations, connected through buses of this form, in effect implementing a fully distributed system.

The computer 201 typically comprises a variety of computer readable media. Exemplary readable media can be any available media that is accessible by the computer 201 and comprises, for example and not meant to be limiting, both volatile and non-volatile media, removable and non-removable media. The system memory 212 comprises computer readable media in the form of volatile memory, such as random access memory (RAM), and/or non-volatile memory, such as read only memory (ROM). The system memory 212 typically contains data such as identifier management data 207 and/or program modules such as operating system 205 and identifier management software 206 that are immediately accessible to and/or are presently operated on by the processing unit 203.

In another aspect, the computer 201 can also comprise other removable/non-removable, volatile/non-volatile computer storage media. By way of example, FIG. 2 illustrates a mass storage device 204 which can provide non-volatile storage of computer code, computer readable instructions, data structures, program modules, and other data for the computer 201. For example and not meant to be limiting, a mass storage device 204 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 204, including by way of example, an operating system 205 and identifier management software 206. Each of the operating system 205 and identifier management software 206 (or some combination thereof) can comprise elements of the programming and the identifier management software 206. Identifier management data 207 can also be stored on the mass storage device 204. Identifier management data 207 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 201 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 203 via a human machine interface 202 that is coupled to the system bus 213, but can be connected by other interface and bus structures, such as a parallel port, game port, an IEEE 1394 Port (also known as a Firewire port), a serial port, or a universal serial bus (USB).

In yet another aspect, a display device 211 can also be connected to the system bus 213 via an interface, such as a display adapter 209. It is contemplated that the computer 201 can have more than one display adapter 209 and the computer 201 can have more than one display device 211. For example, a display device can be a monitor, an LCD (Liquid Crystal Display), or a projector. In addition to the display device 211, other output peripheral devices can comprise components such as speakers (not shown) and a printer (not shown) which can be connected to the computer 201 via Input/Output Interface 210. Any step and/or result of the methods can be output in any form to an output device. Such output can be any form of visual representation, including, but not limited to, textual, graphical, animation, audio, tactile, and the like. The display 211 and computer 201 can be part of one device, or separate devices.

The computer 201 can operate in a networked environment using logical connections to one or more remote computing devices 214a,b,c. By way of example, a remote computing device can be a personal computer, portable computer, smartphone, a server, a router, a network computer, a peer device or other common network node, and so on. Logical connections between the computer 201 and a remote computing device 214a,b,c can be made via a network 215, such as a local area network (LAN) and/or a general wide area network (WAN). Such network connections can be through a network adapter 208. A network adapter 208 can be implemented in both wired and wireless environments. Such networking environments are conventional and commonplace in dwellings, offices, enterprise-wide computer networks, intranets, and the Internet.

For purposes of illustration, application programs and other executable program components such as the operating system 205 are illustrated herein as discrete blocks, although it is recognized that such programs and components reside at various times in different storage components of the computing device 201, and are executed by the data processor(s) of the computer. An implementation of identifier management software 206 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

FIG. 3 is a block diagram illustrating an example system 300 for content management. In one aspect, the system 300 can comprise one or more user devices 302. The user devices 302 can be configured to receive content through a network 304. For example, a user device 302 can comprise a set top box, mobile device, smart phone, computing device, laptop device, tablet device, television, digital streaming device, and the like.

In one aspect, the network 304 can comprise a packet switched network, a non-packet switched network (e.g., quadrature amplitude modulation based network), and/or the like. The network 304 can comprise network adapters, switches, routers, and the like connected through wireless links (e.g., radio frequency, satellite) or physical links (e.g., fiber optic cable, coaxial cable, Ethernet cable). In one aspect, the network 304 can be configured to provide communication from telephone, cellular, modem, and/or other electronic devices from, to and throughout the system 300.

In one aspect, the system 300 can comprise one or more network elements connected to the network 304. For example, one of the network elements can comprise a source device 306. The source device 306 can be configured to deliver content through the network 304. A network element can comprise a first device 308. The first device 308 can be configured to receive content from the source device 306 though the network 304. In one aspect, a network element can comprise a second device 310. The second device 310 can be configured to receive content from the first device 308. A network element can comprise a third device 312. The third device 312 can be configured to receive content from the first device 308. In one aspect, a network element can comprise a fourth device 314. The fourth device 314 can be configured to receive content from the second device 310 and/or third device 312. The fourth device 314 can be configured to provide the content to one or more user devices 302.

In one aspect, the network elements can comprise aggregation routers, multiplexers, modulators, encoders, controllers, content splicers, combiners, receiver, content sources, edge devices, termination systems, and the like. For example, the network elements can comprise elements shown in FIG. 1, such as the program substitutor 122, combiner 117, modulator 115, multiplexer 114, receiver 110, encoder 112, switch 113, control system 118, input source 102, video camera 109, server 110, and the like.

In one aspect, one or more of the network elements can be associated with a corresponding identifier. For example, the source device 306 can be associated with a source identifier. The first device 308 can be associated with a first identifier. The second device 310 can be associated with a second identifier. The third device 312 can be associated with a third identifier. The fourth device 314 can be associated with a fourth identifier. Additionally, other network elements can be associated with one or more identifiers. In one aspect, the identifier associated with a network element can comprise the identifier of another network element. For example, an identifier associated with a network element can comprise an identifier associated with an upstream network element (e.g., a network element that receives content and provides content that subsequently reaches the network element referenced). For example, the first device 308 can be upstream from the third device 312. As an illustration, the third identifier can comprise the first identifier associated with the first device 308 and the source identifier associated with the source device 306. Similarly, the first device 308 can be upstream from the second device 310. As another illustration, the second identifier associated with the second device 310 can comprise the first identifier associated with the first device 308 and the source identifier associated with the source device 306.

In one aspect, an identifier can comprise a string of characters, numbers, symbols, and/or the like. An example identifier can comprise one or more sections, for example, a first section and a second section. The first section can be separated from the second section by a symbol or other character, such as a period or dash.

In one aspect, the first section can indicate information related to content. For example, the first section can comprise identifiers and/or names of the content, content format information, content source information, and the like. As an illustration, the first section can comprise one or more of the following: <Short Name><Format Indicator><Feed Indicator><Third Party Source Identifier>. It should be noted that the brackets and enclosed text are not part of the first section but rather indicate generic fields that can correspond to characters in the first section. In one aspect, the first section can be configured to uniquely identify content channels or sources, regardless of the network path by which the user device 302 receives the content channels.

In one aspect, the first section can comprise characters indicating a third party associated with content. For example, the characters indicating the third party can comprise a third party name converted to a standardized character set. In one aspect, the short name of the first section can be based on a third party name. For example, the short name can be based on a third party naming system. In one aspect, the short name for a local feed can comprise a numeric name (e.g., 23564sL). In one aspect, special characters can be removed from the third party naming system, such as ‘-’, ‘_’, ‘!’, ‘@’, ‘.’, ‘+’, and the like. These removed characters can be replaced with replacement characters as identified by the service provider. As a further example, a ‘+’ character can be replaced by a ‘p’ character. As an illustration, the characters ‘o3+2’ in an identifier can be replaced with ‘o3p2’ in order to prevent errors from occurring at devices not configured to parse the ‘+’ character. In one aspect, spaces can be removed from the third party names. In another aspect, aspect ratio indicators can be removed from the third party names, such as HD/H (e.g., high definition), SD (e.g., standard definition), or DT/D indicators. In another aspect, the feed indicators in the third party names can be removed, such as ‘E’ (e.g., east) or ‘W’ (e.g., west).

In one aspect, the first section can comprise characters (e.g., letters, symbols, numbers) indicating the format of content. As an example, the first section can comprise a format indicator. The format indicator can indicate the format of the content, such as standard definition, high definition, three dimension, adaptable bit rate, and the like. The format indicator can comprise a description of service resolution (e.g., h for HD, s for SD, 3 for 3D, ‘a’ for Adaptable Bitrate).

In one aspect, the first section can comprise characters (e.g., letters, symbols, numbers) indicating the geographic origin of a source where content was received by a service provider. For example, the first section can comprise a feed indicator. The feed indicator can comprise a notation to indicate service source. For example, the feed indicator can comprise a character indicating a geographic location (e.g., ‘E’ for East, ‘W’ for West, ‘S’ for single source, and ‘L’ for local sourced).

In one aspect, the first section can comprise characters (e.g., letters, symbols, numbers) indicating a third party source from which content and/or information about content was received by a service provider. In one aspect, the characters indicating the third party source can comprise an identifier received from the third party. For example, the first section can comprise a third party source identifier. In one aspect, the third party can provide metadata about the content. When a third party source identifier is provided for locally sourced feeds, the third party source identifier can be used. If no source identifier is provided by a third party, a unique source identifier can be created and associated with third party source.

As previously noted, the identifier can comprise a second section. In one aspect, the second section can comprise network topology information, metadata information, source information, delivery information (e.g., delivery protocol), network device identifiers, network device type, network device location, and the like. The second section can be configured to allow identification of a network path. For example, the network path can comprise information indicating the devices in a network. The network path can comprise information indicating the order of the network devices through which content passes to reach a destination device.

In one aspect, the second section can comprise characters (e.g., letters, symbols, numbers) indicating a network topology. For example, the second section can comprise information identifying one or more upstream devices. Upstream devices can be devices in a network between a device and a content source. For example, an upstream device can receive content from a content source or other upstream device and provide the content to the device. As an illustration, the second section of the first identifier of the first device 308 can comprise at least a part of the source identifier. The second section of the second identifier can comprise at least a part of the first identifier and/or the source identifier. The second section of the third identifier can comprise at least a part of the first identifier and/or the source identifier. The second section of the fourth identifier can comprise at least a part of the third identifier, second identifier, first identifier, and/or source identifier.

As an illustration, the second section can comprise the following: <MetadataServerID><Sourcelocation><AspectRatio><DeliveryPlatformName><DeviceIdentifier>|<SCTE-30 Splicing Identifier>. It should be noted that the brackets and enclosed text are not part of the second section but rather indicate generic fields that can correspond to characters in the second identifier.

In one aspect, the second section can comprise characters (e.g., letters, symbols, numbers) indicating metadata information. For example, the second section can comprise an identifier provided by a metadata server. The metadata information can comprise metadata identifiers assigned to source devices (e.g., channel feeds from altered channels, and sourced adaptable bit rate channels). If no identifier is provided from a metadata server, then a new identifier indicating metadata information can be created.

In one aspect, the second section can comprise characters (e.g., letters, symbols, numbers) indicating a source of content and or type of source of content. For example, the second section can comprise a source name. The source name can comprise a source location of an original content stream. For example, the source name can comprise an acronym indicating a location (e.g., DCF, STM, CCP, GBR, PHL, or the like).

In one aspect, the second section can comprise characters (e.g., letters, symbols, numbers) indicating a type of content delivery. For example, the second section can comprise a delivery platform name. The type of content delivery can comprise, for example, SDIP (e.g., standard definition internet protocol), HDIP (e.g., high definition internet protocol), SPTS (e.g., single program transport stream), SAT (e.g., satellite). FIB (e.g., fiber feed), IP (e.g., internet protocol), DFS (e.g., direct feed Satellite), OFA (e.g., Off Air), and the like. The type of content delivery can also comprise an aspect ratio indicator (e.g., 1080i, 1080p, 720p, 480p, and the like).

In one aspect, the second section can comprise characters (e.g., letters, symbols, numbers) indicating one or more types of devices. For example, the second section can comprise a device type. The device type can be a multiplexer device, edge device, aggregate router, content splicer, content groomer, and the like. As an illustration, the following characters can be used: ‘bmr’ (e.g., broadband multimedia-services router), ‘dm’ (e.g., digital multiplexer), ‘edu’ (e.g., edge device unit). ‘ar’ (aggregate router), ‘vipr’ (e.g., vipr video transcoder), ‘cap’ (cherry-picker application platform), and the like.

In one aspect, the second section can comprise characters (e.g., letters, symbols, numbers) indicating a number associated with a device type. For example, the second section can comprise a device sequence number. The device sequence number can be combined with the device type (e.g., dm 01). In some implementations, the device type and device sequence number can be a single field.

In one aspect, the second section can comprise characters (e.g., letters, symbols, numbers) indicating one or more locations by region, state, city, street, address, building, room, server rack and/or other location information. For example, the second section can comprise address information for a site where the device is located.

In one aspect, the second section can comprise characters (e.g., letters, symbols, numbers) indicating a network where a device is located. For example, the second section can comprise a network name. The network name can indicate the logical network on which the device resides. The network name can be based on a domain name system (DNS) architecture standard used by the service provider.

In one aspect, the second section can comprise characters (e.g., letters, symbols, numbers) indicating content insertion information (e.g., advertisements). For example, the second section can comprise an advertisement insertion identifier. As an illustration, the advertisement insertion identifier can be inserted by a multiplexer or other network element in the network 304. By way of example, the advertisement insertion identifier can comprise a SCTE-30 formatted channel name and an advertisement zone identifier. For example, the channel name can comprise the short name or variation thereof as described elsewhere herein.

It should be noted that the various features described for first section and the second section of the identifier are not limited to the first section or second section. For example, aspects of the first section can be implemented in the second section, and aspects of the second section can be implemented in the first section. Additionally, aspects of the fields (e.g., short name, format indicator, feed indicator, third party source identifier, metadata server identifier, source location, aspect ratio, delivery platform, device identifier, splicing identifier) of the first section and second section are not limited to the described fields but can be implemented in other fields. In some implementations additional fields or fewer fields than those described can be implemented. Additionally, the fields described can be implemented with a variety of characters, and are not limited to the examples provided herein.

In one aspect, the source device 306, first device 308, second device 310, third device 312, fourth device 314, and/or other network elements (collectively referred to as network elements) can be configured to insert (e.g., store, save, embed, write, encrypt, append, attach) into the content the identifier associated with the corresponding device or element. As content is received by the network elements (e.g., or some time thereafter), the network elements can insert the identifier of the network element in the content. For example, network elements can insert the identifier in a syntax, header, metadata field or other part of the content. As an illustration, the network elements can insert the identifier of the network element into a service descriptor table (e.g., service_descriptor table) of the content. For example, the content can be delivered through an MPEG stream. The identifier can be inserted into one or more packets of an MPEG stream. For example, the identifier can be inserted into the packets of a packetized elementary stream. The service descriptor table can comprise a service provider name field (e.g., service_provider_name field). In one aspect, the first section of the identifier can be inserted into the service provider name field. The service descriptor table can comprise a service name field (e.g., service_name field). The second section of the identifier can be stored in the service name field.

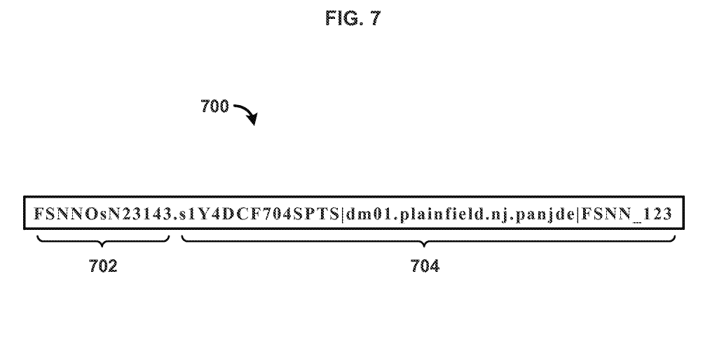

The identifiers are described in further detail through the following non-limiting illustrations. FIG. 7 shows a first example network element 700. By way of illustration, an example identifier of a network element 700 can comprise the following: ‘FSNNOsN23143.s1Y4DCF704SPTS|dm01.plainfield.nj.panjde|FSNN_{—}123, where FSNNOsN23143 is an example first section 702 and s1Y4DCF704SPTS|dm01.plainfield.nj.panjde|FSNN_{—}123 is an example second section 704. Returning to FIG. 3, the example of FIG. 7 is explained with reference to FIG. 3. For example, the example identifier can be the fourth identifier associated with the fourth device 314. As a further illustration, an example second identifier associated with the second device 310 can comprise FSNNOsN23143.s1Y4DCF704SPTS|dm01.plainfield.nj.panjde. As a further illustration, an example first identifier associated with the first device 308 can comprise FSNNOsN23143.s1Y4DCF704SPTS. As a further illustration, the example source identifier associated with the source device 306 can comprise FSNNOsN23143.

The example first section 702 can be described as follows. The first five characters, ‘FSNNO’, can comprise a short name. FSN can indicate a particular channel (e.g., Fox Sports Network). The ‘NO’ can indicate a region of the particular channel (e.g., North). In some implementations, characters indicating a region of the particular channel can be omitted (e.g., when the channel does not have regional feeds). The sixth character ‘s’ is an example format indicator value. In this example, the ‘s’ can indicate that the content is provided in standard definition. The seventh character ‘N’ is an example feed indicator value. For example, the ‘N’ can indicate that the content is provided from a single source feed. The remaining characters of the first section, ‘23143’, are an example third party source identifier. The third party source identifier can comprise a source name provided by a third party.

The example second section 704 can be described as follows. The first four characters ‘s1Y4’ comprise an example identifier from a metadata server. The next three characters ‘DCF’ comprise an example source identifier. The next characters ‘SPTS’ comprise an example delivery platform name. For example, SPTS can indicate the delivery of the content is performed in a single program transport stream (e.g., of an MPEG stream). The next character ‘|’ can separate parts of the identifier. For example, the ‘|’ can indicate that the previous characters comprise a name for an upstream network element. The following characters ‘dm’ are an example of a device type value. For example, the ‘dm’ can indicate that the network element is a digital multiplexer or other similar device. The following characters ‘01’ are an example of a device sequence number. Additionally, ‘plainfield.nj’ is an example of location information. For example, ‘plainfield’ can represent the city of Plainfield, and ‘nj’ can represent the state of New Jersey. The following characters ‘panjde’ are an example of a network name. The remaining characters ‘FSNN_{—}123’ are an example of an advertisement insertion identifier. The characters ‘FSNN’ are an example channel name and ‘123’ is an example advertisement zone identifier.

Depending on the network path taken by the content, the content can comprise different identifiers corresponding to the devices in the network path traveled by the content. For example, content received at the fourth device 314 can pass through either the second device 310 or the third device 312. As an illustration, the second identifier can comprise, for example, the characters ‘FSNNOsN23143.s1Y4DCF704SPTS|DM02’ (e.g., when the second device 310 comprises a digital multiplexer associated with the characters ‘02’), and the third identifier can comprise, for example, the characters ‘FSNNOsN23143.s1Y4DCF704SPTS|BMR05’ (e.g., when the third device 312 comprises a broadband multimedia-services router associated with the characters ‘05’). In one aspect, the fourth device 314 can insert the fourth identifier by appending at least a part of an identifier to either the second identifier or third identifier. As an illustration, the fourth device can append, for example, the characters ‘FSNN_{—}123’ (e.g., as an advertisement insertion identifier). If the fourth device receives content from the second device, the fourth identifier inserted into the content can comprise ‘FSNNOsN23143.s1Y4DCF704SPTS|DM02|FSNN_{—}123’. If the fourth device 314 receives content from the second device, the fourth identifier inserted into the content can comprise ‘FSNNOsN23143.s1Y4DCF704SPTS|BMR05|FSNN_{—}123’. Accordingly, identifiers can be inserted into the content in a variety of ways, and the content can comprise a variety of characters depending on the path of the content through the network 304.

In one aspect, the system 300 can comprise an analysis device 316. The analysis device 316 can be configured to analyze content to discover the network path of the content. In one aspect, the analysis device 316 can determine the identifier of one or more network elements stored in the content. For example, the analysis device 316 can determine the identifier in a header of the content. As a further illustration, the analysis device 316 can determine the identifier in a service descriptor table. As an example, the analysis device 316 can determine the identifier in one or more of the service provider name field or service name field of the service descriptor table. The identifier determined in the content can comprise one or more identifiers of network elements through which the content passed in the network 304.

In one aspect, the analysis device 316 can be configured to parse the identifier into multiple identifiers identifying the network elements through which the content passed. For example, a special character in the identifier can logically separate the identifier into several distinguishable identifiers. For example, a special character in the identifier can indicate that the characters preceding the special character are the characters for an identifier of an upstream network element. The special character can indicate that the characters in the identifier following the special character are characters for a network element downstream from the network element identified in the characters preceding the special character. As an illustration, the special character can comprise a pipe (e.g., ‘|’), a period (e.g., ‘.’) or other suitable character. In one aspect, the special character can be identified based on the location of the character. In another aspect, some special characters can be located in one place, while other special characters can be located (e.g., repeated) in more than one place.

In one aspect, the analysis device 316 or other network element can be used to identify problems in the network 304. For example, a user viewing content at the user device 302 on a content channel can notice a technical problem with the content (e.g., distortion, noise, lack of signal). The user can communicate the issue with the service provider that manages the network 304. The service provider can use the analysis device 316 to tune into the content channel (e.g., if the content channel is provided to the user device 302 on a quadrature amplitude modulation network) or otherwise receive the content. After receiving the content, the analysis device 316 can identify the one or more identifiers of network elements inserted into the content. Then, the service provider can inspect the network elements identified by the one or more identifiers stored in the content. The identified network elements can be inspected for technical problems related to hardware, software, configuration, and the like.

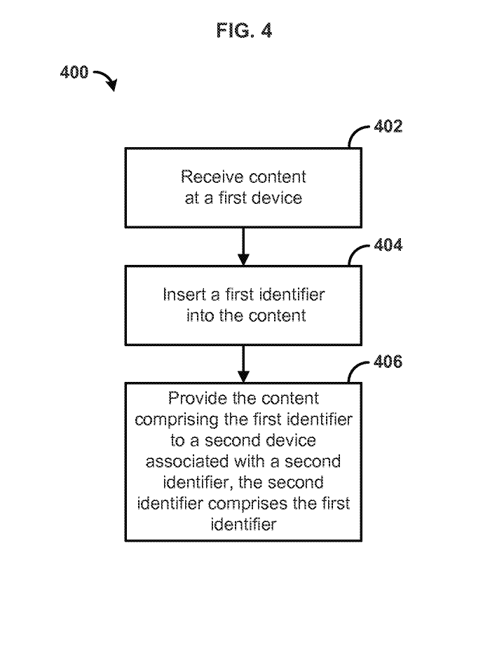

FIG. 4 is a flowchart illustrating an example method 400 for managing content. In step 402, content can be received at a first device. The content can comprise audio, video, images, text, and/or other media. For example, the content can comprise a video stream, such as a motion pictures expert group (MPEG) stream. In one aspect, the content can comprise a plurality of data packets comprising a program, show, movie, or other content item. The first device can be associated with a first identifier. In one aspect, the first identifier can uniquely identify a channel source associated with the content. For example, the first identifier can identify a channel from which the content is received.

In step 404, the first identifier can be inserted (e.g., stored, saved, embedded, written, encrypted, appended, attached) into the content. For example, the first identifier can be inserted into a data syntax of the content. The data syntax can be a metadata field, table, header, field embedded in content, or the like. As a further example, the first identifier can be inserted into a service descriptor table (e.g., service_descriptor table) of an MPEG stream. For example, the first identifier can be inserted into one or more fields of the service descriptor table. The first identifier can be inserted into one or more packets of an MPEG stream. For example, the first identifier can be inserted into the packets of a packetized elementary stream. As an illustration, at least a part of the first identifier can be inserted into the service name field (e.g., service_name field). As another illustration, at least a part of the first identifier can be inserted into the service provider name field (e.g., service_provider_name field).

In step 406, the content comprising the first identifier can be provided to a second device associated with a second identifier. In one aspect, the second identifier can comprise the first identifier. In one aspect, the second device can be configured to insert the second identifier in the content.

In one aspect, an identifier (e.g., first identifier, second identifier) can indicate information related to content. For example, an identifier can comprise identifiers and/or names of the content or devices, content format information, content source information, and the like.

In one aspect, an identifier can comprise characters (e.g., letters, symbols, numbers) indicating a third party associated with content. For example, the characters indicating the third party name can comprise a third party name converted to a standardized character set. In one aspect, an identifier can comprise characters indicating the format of content. In one aspect, an identifier can comprise characters indicating the geographic origin of a source where content was received by a service provider. In one aspect, an identifier can comprise characters indicating a third party source from which content and/or information about content was received by a service provider.

In one aspect, an identifier can comprise network topology information, metadata information, source information, delivery information (e.g., delivery protocol), network device identifiers, network device type, network device location, and the like. For example, an identifier can be configured to allow identification of a network path. For example, the network path can comprise information indicating the devices of a network. The network path can comprise information indicating the order of the network devices through which content passes to reach a destination device.

In one aspect, an identifier can comprise characters (e.g., letters, symbols, numbers) indicating a network topology. In one aspect, an identifier can comprise characters indicating metadata information. In one aspect, an identifier can comprise characters indicating a source of content and or type of source of content. In one aspect, an identifier can comprise characters indicating a type of content delivery. In one aspect, an identifier can comprise characters indicating one or more types of devices. In one aspect, an identifier can comprise characters indicating a number associated with a device type. In one aspect, an identifier can comprise characters indicating one or more locations by region, state, city, street, address, building, room, server rack and/or other location information. In one aspect, an identifier can comprise characters indicating a network where a device is located. In one aspect, an identifier can comprise characters indicating content insertion information (e.g., advertisements).

The first device and/or second device can comprise a multiplexer, content splicer, router, aggregator, modulator, encoder, switch, server, edge device, and/or the like. For example, the first device and/or second device can comprise a device located in the system 100 of FIG. 1 and/or the system 300 of FIG. 3. In one aspect, the first device and the second device can be located in a content delivery network configured to provide media content to subscribers. For example, the content delivery network can comprise a packet switched network (e.g., internet protocol based network), non-packet switched network (e.g., quadrature amplitude modulation based network), wireless link (e.g., satellite, Wi-Fi, cellular), and/or wire link (e.g., fiber optic cable, Ethernet cable, coaxial cable). In one aspect, the second device can be downstream from the first device in the content delivery network. For example, a downstream device can be a device that receives content from one or more upstream devices and provides the content to another device in the network. The upstream devices can receive the content from a source device or an upstream device that received the content from the source device. In one aspect, the first identifier and/or second identifier indicates a network path of the content through the content delivery network.

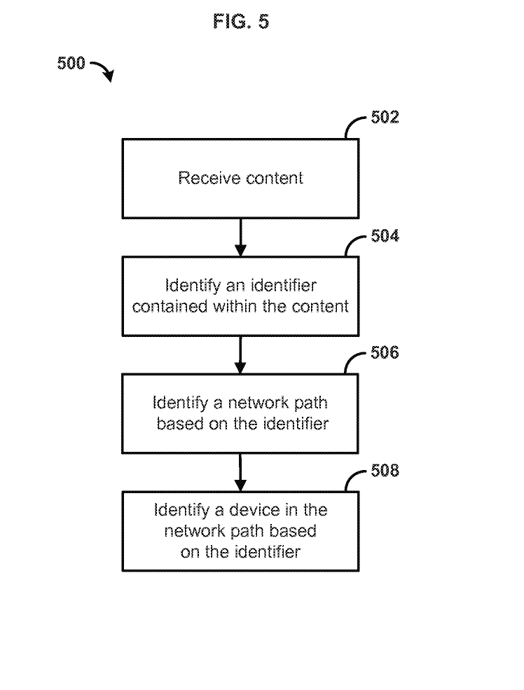

FIG. 5 is a flowchart illustrating another example method 500 for content management. In step 502, content can be received. The content can comprise audio, video, images, text, and/or other media. For example, the content can comprise a video stream, such as a motion pictures expert group (MPEG) stream. In one aspect, the content can comprise a plurality of data packets comprising a program, show, movie, or other content item. For example, content can be received by a network device (e.g., network element or analysis device 316 of FIG. 3).

In step 504, an identifier contained within the content can be determined. In one aspect, the identifier can uniquely identify a channel source associated with the content. For example, the identifier can uniquely identify a channel from which the content is received. In one aspect, the identifier can be identified in a data syntax of the content. The data syntax can be a metadata field, table, header, field embedded in content, or the like. As an example, the identifier can be identified in a service descriptor table of a motion pictures expert group (MPEG) stream. The identifier can be identified in one or more packets of an MPEG stream. For example, the identifier can be identified in the packets of a packetized elementary stream. For example, the identifier can be identified (e.g., as previously stored, saved, embedded, written, encrypted, appended, attached) in one or more fields of the service descriptor table. As an illustration, at least a part of the identifier can be identified in the service name field (e.g., service_name field). As another illustration, at least a part of the identifier can be identified in the service provider name field (e.g., service_provider_name field).

In one aspect, the identifier can indicate information related to content. For example, the identifier can comprise identifiers and/or names of the content, content format information, content source information, and the like. In one aspect, the identifier can comprise characters (e.g., letters, symbols, numbers) indicating a third party associated with content. For example, the characters indicating the third party name can comprise a third party name converted to a standardized character set. In one aspect, the identifier can comprise characters indicating the format of content. In one aspect, the identifier can comprise characters indicating the geographic origin of a source where content was received by a service provider. In one aspect, the identifier can comprise characters indicating a third party source from which content and/or information about content was received by a service provider.

In one aspect, the identifier can comprise network topology information, metadata information, source information, delivery information (e.g., delivery protocol), network device identifiers, network device type, network device location, and the like. For example, the identifier can be configured to allow identification of a network path. For example, the network path can comprise information indicating the devices of a network. The network path can comprise information indicating the order of the network devices through which content passes to reach a destination device.

In one aspect, the identifier can comprise characters (e.g., letters, symbols, numbers) indicating a network topology. In one aspect, the identifier can comprise characters indicating metadata information. In one aspect, the identifier can comprise characters indicating a source of content and or type of source of content.

In one aspect, the identifier can comprise characters indicating a type of content delivery. In one aspect, the identifier can comprise characters indicating one or more types of devices. In one aspect, the identifier can comprise characters indicating a number associated with a device type. In one aspect, the identifier can comprise characters indicating one or more locations by region, state, city, street, address, building, room, server rack and/or other location information. In one aspect, the identifier can comprise characters indicating a network where a device is located. In one aspect, the identifier can comprise characters indicating content insertion information (e.g. advertisements).

In step 506, a network path can be identified based on the identifier. For example, the network path can be indicated by characters in the identifier. The network path can be a path of devices in a network through which the content passed through. For example, network topology information can be identified within or based upon the identifier. As an illustration, the identifier can comprise identifiers for one or more devices in a network. The identifiers for the one or more devices in the network can be arranged within the identifier such that a path of devices (e.g., ordered list of devices) through which content traveled can be determined. Accordingly, identifying a network path based on the identifier can comprise identify one or more devices in the network path and/or an order of the one or more devices in the network path based on the arrangement of characters in the identifier.

In step 508, a device in the network path can be identified based on the identifier. For example, the identifier can comprise an identifier unique to the device. The device can comprise a multiplexer, content splicer, router, aggregator, modulator, encoder, switch, server, edge device, and/or the like. For example, the device can comprise a device located in the system 100 of FIG. 1 and/or the system 300 of FIG. 3. In one aspect, the device can be located in a content delivery network configured to provide media content to subscribers. For example, the content delivery network can comprise a packet switched network (e.g., internet protocol based network), non-packet switched network (e.g., quadrature amplitude modulation based network), wireless link (e.g., satellite, Wi-Fi, cellular), and/or wire link (e.g., fiber optic cable. Ethernet cable, coaxial cable). In another aspect, the device can be configured to insert at least a part of the identifier in the content. For example, the device can append, attach, or otherwise write an identifier within the content. As a further example, the device can append additional characters onto an identifier within the content, and the additional characters can identify the device.

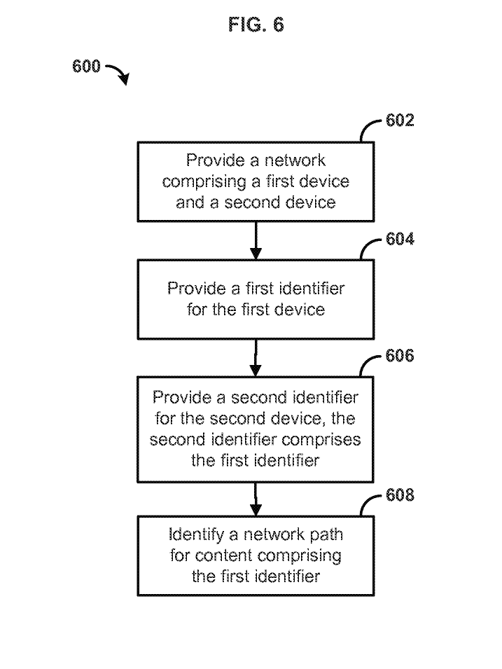

FIG. 6 is a flowchart illustrating yet another example method 600 for content management. In step 602, a network comprising a first device and a second device can be provided. The first device and/or second device can comprise a multiplexer, content splicer, router, aggregator, modulator, encoder, switch, server, edge device, and/or the like. For example, the first device and/or second device can comprise a device located in the system 100 of FIG. 1 and/or the system 300 of FIG. 3.

In one aspect, the first device and the second device can be located in a content delivery network configured to provide media content to subscribers. For example, the content delivery network can comprise a packet switched network (e.g., internet protocol based network), non-packet switched network (e.g., quadrature amplitude modulation based network), wireless link (e.g., satellite, Wi-Fi, cellular), and/or wire link (e.g., fiber optic cable, Ethernet cable, coaxial cable). For example, the second device can be downstream from the first device in the content delivery network. For example, a downstream device can be a device that receives content from one or more upstream devices and provides the content to another device in the network. The upstream devices can receive the content from a source device or an upstream device that received the content from the source device.

In step 604, a first identifier can be provided for the first device. In one aspect, the first identifier can uniquely identify a channel source associated with the content. For example, the first identifier can uniquely identify a channel source from which the content is received. In one aspect, the first device can be configured to insert the first identifier into a data syntax of the content. The data syntax can be a metadata field, table, header, field embedded in content, or the like. For example, the first device can be configured to insert the first identifier into a service descriptor table of a motion pictures expert group (MPEG) stream. The first identifier can be inserted into one or more packets of an MPEG stream. For example, the first identifier can be inserted into the packets of a packetized elementary stream. For example, the identifier can be inserted into one or more fields of the service descriptor table. As an illustration, at least a part of the identifier can be inserted into the service name field (e.g., service_name field). As another illustration, at least a part of the identifier can be inserted into the service provider name field (e.g., service_provider_name field).

In step 606, a second identifier can be provided for the second device. In one aspect, the second identifier can comprise the first identifier. In one aspect, the second device can be configured to insert the second identifier in the content. For example, the second device can append, attach, or otherwise write the second identifier within the content. As a further example, the second device can append additional characters onto the first identifier within the content, and the additional characters can identify the second device.

In one aspect, an identifier (e.g., first identifier, second identifier) can indicate information related to content. For example, an identifier can comprise identifiers and/or names of the content, content format information, content source information, and the like.

In one aspect, an identifier can comprise characters (e.g., letters, symbols, numbers) indicating a third party associated with content. For example, the characters indicating the third party name can comprise a third party name converted to a standardized character set. In one aspect, an identifier can comprise characters indicating the format of content. In one aspect, an identifier can comprise characters indicating the geographic origin of a source where content was received by a service provider. In one aspect, an identifier can comprise characters indicating a third party source from which content and/or information about content was received by a service provider.

In one aspect, an identifier can comprise network topology information, metadata information, source information, delivery information (e.g., delivery protocol), network device identifiers, network device type, network device location, and the like. For example, an identifier can be configured to allow identification of a network path. For example, the network path can comprise information indicating the devices of a network. The network path can comprise information indicating the order of the network devices through which content passes to reach a destination device.

In one aspect, an identifier can comprise characters (e.g., letters, symbols, numbers) indicating a network topology. In one aspect, an identifier can comprise characters indicating metadata information. In one aspect, an identifier can comprise characters indicating a source of content and or type of source of content. In one aspect, an identifier can comprise characters indicating a type of content delivery. In one aspect, an identifier can comprise characters indicating one or more types of devices. In one aspect, an identifier can comprise characters indicating a number associated with a device type. In one aspect, an identifier can comprise characters indicating one or more locations by region, state, city, street, address, building, room, server rack and/or other location information. In one aspect, an identifier can comprise characters indicating a network where a device is located. In one aspect, an identifier can comprise characters indicating content insertion information (e.g., advertisements).

In step 608, a network path for content comprising the first identifier can be identified. For example, the network path can be indicated by characters in the identifier. The network path can be a path of devices in a network through which the content has passed. For example, network topology information can be identified within or based upon an identifier (e.g., first identifier, second identifier). As an illustration, the identifier can comprise identifiers for one or more devices in a network. The identifiers for the one or more devices in the network can be arranged within the identifier such that a path of devices (e.g., ordered list of devices) through which content traveled can be determined. Accordingly, identifying a network path based on the first identifier can comprise identify one or more devices in the network path and/or an order of the one or more devices in the network path based on characters in the first identifier and/or the arrangement of characters in the first identifier.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method, comprising,
receiving content at a first device, wherein the first device is associated with a first identifier;
inserting the first identifier into the content; and
providing the content comprising the first identifier to a second device associated with a second identifier, wherein the second identifier comprises the first identifier.

2. The method of claim 1, wherein the first identifier uniquely identifies a channel source associated with the content.

3. The method of claim 1, wherein inserting the first identifier into the content comprises inserting the first identifier in a data syntax of the content.

4. The method of claim 3, wherein inserting the first identifier into the content comprises inserting the first identifier in a service descriptor table of a motion pictures expert group (MPEG) stream.

5. The method of claim 1, wherein the first device and the second device are located in a content delivery network configured to provide media content to subscribers.

6. The method of claim 5, wherein the second device is downstream from the first device in the content delivery network.

7. The method of claim 5, wherein the first identifier indicates a network path of the content through the content delivery network.

8. A method, comprising:
receiving content;
identifying an identifier contained within the content;
identifying a network path based on the identifier; and
identifying a device in the network path based on the identifier.

9. The method of claim 8, wherein the identifier uniquely identifies a channel source associated with the content.

10. The method of claim 8, wherein identifying the identifier contained within the content comprises identifying an identifier in a data syntax of the content.

11. The method of claim 10, wherein identifying the identifier contained within the content comprises identifying the identifier in a service descriptor table of a motion pictures expert group (MPEG) stream.

12. The method of claim 8, wherein the device is located in a content delivery network configured to provide media content to subscribers.

13. The method of claim 8, wherein the device is configured to insert at least a part of the identifier in the content.

14. A method for managing content, comprising:
providing a first identifier for a first device in a network;
providing a second identifier for a second device in the network, wherein the second identifier comprises the first identifier; and
identifying a network path for content comprising the first identifier.

15. The method of claim 14, wherein the first identifier uniquely identifies a channel source associated with the content.

16. The method of claim 14, wherein the first device is configured to insert the first identifier in a data syntax of the content.

17. The method of claim 16, wherein the first device is configured to insert the first identifier in a service descriptor table of a motion pictures expert group (MPEG) stream.

18. The method of claim 14, wherein the first device and the second device are located in a content delivery network configured to provide media content to subscribers.

19. The method of claim 18, wherein the second device is downstream from the first device in the content delivery network.

20. The method of claim 14, wherein the second device is configured to insert the second identifier in the content.
